(19) United States
(12) Patent Application Publication
(10) Pub. No.: US 2014/0244321 A1
(43) Pub. Date: Aug. 28, 2014

(54) TICKET PROCESSING SYSTEM, CONTROL METHOD FOR TICKET PROCESSING SYSTEM, AND PROGRAM

(71) Applicant: Rakuten, Inc., Tokyo (JP)

(72) Inventors: Kenta MATSUI, Tokyo (JP); Misato TAKAHASHI, Tokyo (JP); Moriyoshi KOIZUMI, Tokyo (JP); Shin AOYAMA, Tokyo (JP)

(73) Assignee: Rakuten, Inc., Tokyo (JP)

(21) Appl. No.: 14/187,346

(22) Filed: Feb. 24, 2014

(30) Foreign Application Priority Data
Dec. 25, 2012 (JP) 2012-281852

(51) Int. Cl. G06Q 10/02

(52) U.S. Cl. CPC G06Q 10/02
USPC 705/5

(57) ABSTRACT

A first reception unit receives an application for purchasing a physical ticket or an electronic ticket from a user. A purchase processing executing unit executes purchase processing of the ticket in a case where the application for purchasing the ticket is received. A second reception unit receives an application for canceling or transferring the ticket from a purchasing user who has purchased the ticket. An exhibition processing executing unit executes an exhibition processing for putting up the ticket for an auction service in a case where the application for canceling or transferring the ticket is received.

### TECHNICAL FIELD

The present invention relates to a ticket processing system, a control method for a ticket processing system, and a program.

### BACKGROUND ART

There is known a system for selling tickets for a concert, a sports game, or the like. For example, Patent Literature 1 discloses a system for issuing an electronic ticket to a user.

### CITATION LIST

### Patent Literature

Patent Literature 1: JP 2012-73890 A

### SUMMARY OF INVENTION

### Technical Problem

In general, cancellation of the ticket for a concert, a sports game, or the like is not permitted, and hence when a purchaser of a ticket cannot go to a concert, a sports game, or the like, the ticket is wasted. In this respect, for example, if the purchaser puts up the ticket for an auction service, a person who failed to purchase the ticket can purchase the ticket, and hence the ticket is not wasted, thus ensuring effective use of tickets.

However, promoters often prohibit tickets from being put up for an auction service because resale of tickets may lead to, for example, a fraud. If exhibition of a ticket to an auction service is permitted, a person who failed to purchase the ticket may not believe the validity of the ticket or the exhibitor, and may hesitate to purchase the ticket through the auction service. For those reasons, it has been difficult to ensure effective use of canceled tickets.

### Solution to Problem

The present invention has been made in view of the above-mentioned problem, and it is an object of the present invention to provide a ticket processing system, a control method for a ticket processing system, and a program capable of preventing troubles in reselling tickets and ensuring effective use of canceled tickets.

In order to solve the above-mentioned problem, a ticket processing system according to one embodiment of the present invention is a ticket processing system, including: first reception means for receiving, from a user, an application for purchasing a ticket that is one of a physical ticket and an electronic ticket; purchase processing executing means for executing purchase processing of the ticket in a case where the application for purchasing the ticket is received; second reception means for receiving an application for one of canceling and transferring of the ticket from a purchasing user who has purchased the ticket; and exhibition processing executing means for executing exhibition processing for putting up the ticket for an auction service in a case where the application for the one of canceling and transferring of the ticket is received.

Further, a control method for a ticket processing system according to one embodiment of the present invention is a control method for a ticket processing system, the control method including: a first reception step of receiving, from a user, an application for purchasing a ticket that is one of a physical ticket and an electronic ticket; a purchase processing executing step of executing purchase processing of the ticket in a case where the application for purchasing the ticket is received; a second reception step of receiving an application for one of canceling and transferring of the ticket from a purchasing user who has purchased the ticket; and an exhibition processing executing step of executing exhibition processing for putting up the ticket for an auction service in a case where the application for the one of canceling and transferring of the ticket is received.

Further, a program according to one embodiment of the present invention is a program for causing a computer to function as: first reception means for receiving, from a user, an application for purchasing a ticket that is one of a physical ticket and an electronic ticket; purchase processing executing means for executing purchase processing of purchasing the ticket in a case where the application for purchasing the ticket is received; second reception means for receiving an application for one of canceling and transferring of the ticket from a purchasing user who has purchased the ticket; and exhibition processing executing means for executing exhibition processing for putting up the ticket for an auction service in a case where the application for the one of canceling and transferring of the ticket is received.

Further, a computer-readable information storage medium according to one embodiment of the present invention is a computer-readable information storage medium having the above-mentioned program recorded thereon.

Further, in an aspect of the present invention, the ticket processing system may further include collection amount determining means for determining, in a case where the ticket which is put up for the auction service is bid on successfully, an amount to be collected from the purchasing user who has made the application for the one of canceling and transferring of the ticket based on a purchase price when the purchasing user has purchased the ticket and a successful bid price for the ticket in the auction service.

Further, in an aspect of the present invention, the collection amount determining means may determine the amount to be collected from the purchasing user based on a result of determination as to whether the successful bid price is higher than a reference price which is determined based on the purchase price.

Further, in an aspect of the present invention, the collection amount determining means may determine that the amount to be collected from the purchasing user is zero in a case where the successful bid price is higher than the reference price.

Further, in an aspect of the present invention, the purchase processing executing means may include means for executing processing for issuing an electronic ticket to the purchasing user, and the ticket processing system may further include: means for executing processing for disabling use of the electronic ticket issued to the purchasing user in the case where the application for the one of canceling and transferring of the ticket is received;

and means for executing processing for issuing a new electronic ticket to a user who has made a successful bid for the ticket in the case where the ticket which is put up for the auction service is bid on successfully.

Further, in an aspect of the present invention, the ticket processing system may further include: means for determining a minimum price; and means for restricting a successful bid for the ticket from being made at a successful bid price lower than the minimum price in the auction service.

Further, in an aspect of the present invention, the ticket processing system may further include: price control means for reducing a price of the ticket which is put up for the auction service with passage of time; means for receiving an application for bidding for the ticket which is put up for the auction service from a user; and means for determining a price at a time when the application for bidding for the ticket is received as a successful bid price, and the price control means may include at least one of: means for setting a speed of reducing the price on a day specified by the ticket greater than a speed of reducing the price before the day specified by the ticket; or means for setting the speed of reducing the speed after a date and time specified by the ticket greater than the speed of reducing the price before the date and time specified by the ticket.

Further, in an aspect of the present invention, the ticket processing system may further include means for executing processing for transferring the ticket to a user who has a predetermined relationship with the purchasing user in a case where the ticket which is put up for the auction service is not bid on successfully.

According to one embodiment of the present invention, if a seller and a reseller are identical or have a fiduciary relation with each other, it is possible to ensure effective use of canceled tickets while keeping the reliability of the tickets. For electronic tickets, especially, the processing of the tickets becomes significantly easy.

### BRIEF DESCRIPTION OF DRAWINGS

FIG. 1 is a diagram illustrating an example of the overall configuration of a ticket processing system according to an embodiment of the present invention.

FIG. 2 is a diagram illustrating an example of the hardware configuration of a ticket processing server.

FIG. 3 is a diagram illustrating an example of a purchase screen.

FIG. 4 is a diagram illustrating an example of a purchase history screen.

FIG. 5 is a diagram illustrating an example of a bid screen.

FIG. 6 is a diagram showing an example of a successful bid fee, a cancellation fee, and a refund to a user who canceled a ticket.

FIG. 7 is a diagram showing an example of a user table.

FIG. 8 is a diagram showing an example of an event table.

FIG. 9 is a diagram showing an example of a ticket table.

FIG. 10 is a diagram showing an example of an exhibition table.

FIG. 11 is a diagram showing an example of a bid history table.

FIG. 12 is a diagram showing an example of a charge history table.

FIG. 13 is a functional block diagram of the ticket processing system.

FIG. 14 is a diagram illustrating an example of processing that is executed in the ticket processing system.

FIG. 15 is a diagram illustrating an example of processing that is executed in the ticket processing system.

FIG. 16 is a diagram illustrating an example of processing that is executed in the ticket processing system.

FIGS. 17A to 17C are diagrams for explaining processing that is executed in the ticket processing system.

### DESCRIPTION OF EMBODIMENTS

Now, an example of an embodiment of the present invention is described in detail referring to the accompanying drawings.

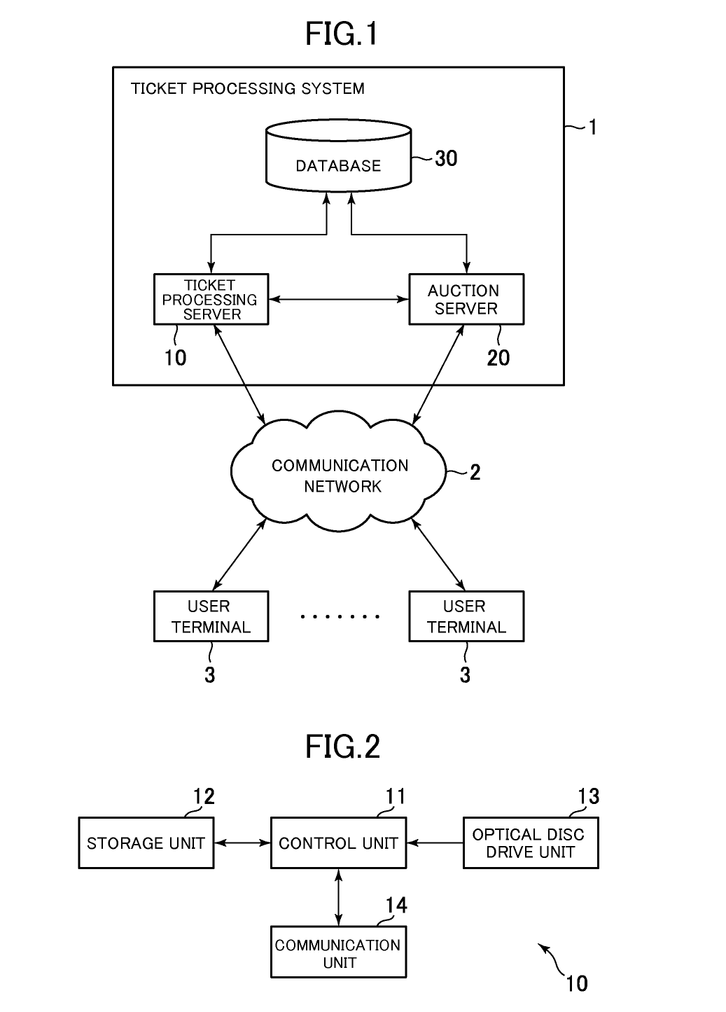

FIG. 1 is a diagram illustrating an example of the overall configuration of a ticket processing system according to the embodiment of the present invention. As illustrated in FIG. 1, the ticket processing system 1 according to this embodiment includes a ticket processing server 10, an auction server 20, and a database 30.

The ticket processing server 10 is a server for providing a ticket sales service. The ticket processing server 10 executes processing relating to the ticket sales service in response to a request from a user terminal 3. The ticket sales service may be designed not to physically issue tickets, but to issue what is called electronic tickets, which are managed based on IDs, to users, or maybe designed to issue physical tickets typified by paper tickets to users.

The following mainly describes a case where the ticket processing server 10 provides a ticket sales service for issuing electronic tickets to users. In this ticket sales service, for example, data for permitting the user terminal 3 to serve as a ticket is transmitted to the user terminal 3, and the user terminal 3 is used as a ticket. As a method of permitting the user terminal 3 to serve as a ticket, for example, there may be adopted a method of displaying a code image (bar code, QR code (registered trademark), or the like) on a display unit of the user terminal 3, or a method of using a near field communication (NFC) contactless IC card function of the user terminal 3.

FIG. 2 is a diagram illustrating an example of the hardware configuration of the ticket processing server 10. As illustrated in FIG. 2, the ticket processing server 10 includes a control unit 11, a storage unit 12, an optical disc drive unit 13, and a communication unit 14.

The control unit 11 includes at least one microprocessor, and executes processing in accordance with an operating system or program stored in the storage unit 12. The storage unit 12 includes a main memory unit and an auxiliary storage unit. For example, the main memory unit is a RAM, and the auxiliary storage unit is a hard disk drive, a solid state drive, or the like.

The optical disc drive unit 13 reads a program and data recorded on an optical disc (information storage medium) . The program and data are supplied to the storage unit 12 via the optical disc. In other words, a program and data recorded on an optical disc are read by the optical disc drive unit 13, and are stored in the storage unit 12.

The ticket processing server 10 may be configured to include a component for reading a program and data stored in an information storage medium (e.g., memory card) other than an optical disc so that the program and data are supplied to the storage unit 12 via the information storage medium other than an optical disc.

The communication unit 14 executes data communication over a communication network 2. The program and data may be supplied to the storage unit 12 over the communication network 2.

The auction server 20 is a server for providing an online auction service. The auction server 20 executes processing relating to an auction service in response to a request from the user terminal 3 or the ticket processing server 10.

The hardware configuration of the auction server 20 is similar to that of the ticket processing server 10. The ticket processing server 10 and the auction server 20 can communicate data with each other. The ticket processing server 10 and the auction server 20 may be implemented by a single server computer.

Because a case where the same provider provides the ticket sales service and the auction service is assumed in FIG. 1, the auction server 20 is included in the ticket processing system 1. However, the ticket sales service and the auction service may be provided by separate providers. In other words, the auction server 20 may not be included in the ticket processing system 1, and provided outside the ticket processing system 1. In this case, a ticket sales service provider and an auction service provider generally have established a fiduciary relation about handing of tickets with each other.

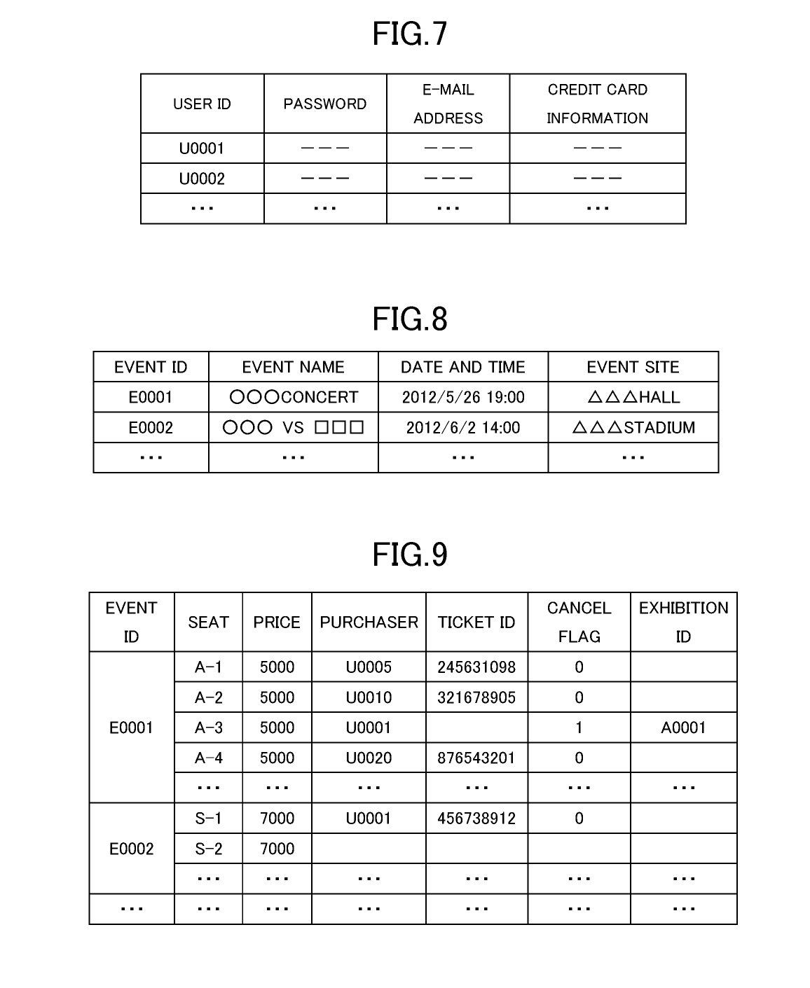

The ticket processing server 10 and the auction server 20 can access the database 30. The database 30 may be built in a server computer different from the ticket processing server 10 and the auction server 20, or may be built in one of the ticket processing server 10 and the auction server 20. For example, data needed to provide the ticket sales service and data needed to provide the auction service are stored in the database 30. The data to be stored in the database 30 is described later (see FIGS. 7 to 12).

When the ticket sales service and the auction service are provided by separate providers, a database where data needed to provide the ticket sales service is stored and a database where data needed to provide the auction service is stored may be built separately. Even when the ticket sales service and the auction service are provided by the same provider, the above-mentioned databases may be built separately.

The user terminal 3 is an information processing apparatus used by a user. The user terminal 3 is, for example, a cellular phone, a portable information terminal, or a personal computer. The ticket processing server 10 and the user terminal 3 can execute data communication with each other over the communication network 2. The auction server 20 and the user terminal 3 can also execute data communication with each other over the communication network 2.

Procedures to be executed by a user in using the ticket sales service is described below. First, the user executes a procedure for user registration. For example, the user accesses a Web page for user registration provided by the ticket processing server 10 from the user terminal 3. Then, the user inputs his/her own information (e.g., password, e-mail address, and credit card information) on a user registration screen displayed on the display unit of the user terminal 3.

Information input on the user registration screen is transmitted to the ticket processing server 10, and stored in the database 30. At this time, a user ID for uniquely identifying the user is generated, and the information input on the user registration screen is stored in association with the user ID. The user ID may be specified by the user.

The user who wants to purchase a ticket through the ticket sales service accesses the ticket processing server 10 from the user terminal 3. After authentication on the user is completed, the user selects a desired ticket from the tickets that are provided by the ticket sales service. When the desired ticket is selected by the user, a purchase screen for purchasing the ticket is displayed on the display unit of the user terminal 3.

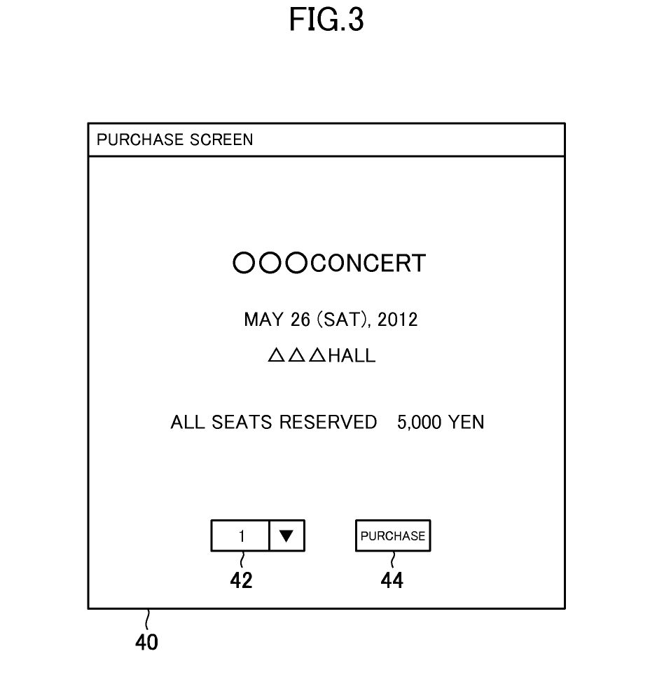

FIG. 3 illustrates an example of the purchase screen. Information on the ticket selected by the user (event name, date and time, location, seat, and price) is displayed on the purchase screen 40. A number-of-tickets field 42 and a purchase button 44 are also displayed on the purchase screen 40. After checking the information on the ticket, the user specifies the number of tickets in the number-of-tickets field 42, and clicks the purchase button 44.

When the purchase button 44 is clicked, purchase processing of a ticket is executed. For example, settlement processing and issuance processing of an electronic ticket are carried out. After those processes are executed, for example, a purchase history screen 50 showing the purchase history of the user is displayed on the display unit of the user terminal 3.

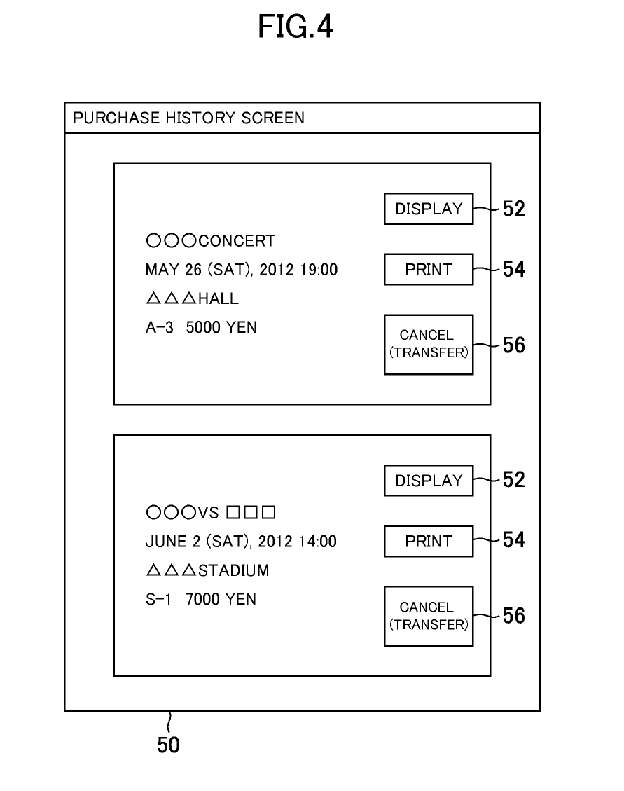

FIG. 4 illustrates an example of the purchase history screen. A list of tickets purchased by the user is displayed on the purchase history screen 50. In the purchase history screen 50, a display button 52 and a print button 54 are displayed in association with each ticket.

When the display button 52 is clicked, a code image representing identification information on the ticket (ticket ID) is displayed on the display unit of the user terminal 3. In this case, the user terminal 3 serves as a ticket. In other words, the user presents the code image displayed on the display unit of the user terminal 3 at the time of entering an event site on the date of the event. In this case, the code image displayed on the display unit of the user terminal 3 is read to check whether the user has purchased the ticket for the event.

When the print button 54 is clicked, a code image representing the ticket identification information (ticket ID) is printed by a printer that is communicable to/from the user terminal 3. In this case, a paper having the code image printed thereon serves as a ticket. In other words, the user presents the code image printed on the paper at the time of entering an event site on the day of the event. In this case, the code image printed on the paper is read to check whether the user has purchased the ticket for the event.

In the purchase history screen 50, a cancel (transfer) button 56 is displayed in association with each ticket that can be canceled (transferred). The cancel (transfer) button 56 is used to cancel a ticket. As described later, in the ticket processing system 1, a canceled ticket can be put up for the auction service provided by the auction server 20 to be transferred to a successful bidder. Accordingly, the cancel (transfer) button 56 can be said to be a button for putting up a ticket for the auction service, or a button for transferring a ticket to anyone else.

When the cancel (transfer) button 56 is clicked, the ticket processing server 10 requests the auction server 20 to put up the ticket for auction. In response to the request from the ticket processing server 10, the auction server 20 puts up the ticket for auction. In this case, a ticket selling company (provider of the ticket sales service), not the user who has canceled the ticket, is set as the exhibitor of the ticket.

For example, a user who failed to purchase a desired ticket through the ticket sales service can get the ticket by making a successful bid for the ticket that is put up for auction.

Procedures for the user to make a successful bid for a ticket that is put up for auction are described below. In the ticket processing system 1, user information is shared between the ticket sales service and the auction service so that a user who has completed user registration for using the ticket sales service can use the auction service. When user information is not shared between the ticket sales service and the auction service, the user needs to carry out procedures for user registration for using the auction service in addition to the procedures for user registration for using the ticket sales service.

A user who wants to make a successful bid for a ticket that is put up for auction accesses the auction server 20 from the user terminal 3. After the user authentication is completed, the user selects a desired ticket from the tickets that are put up for auction. When the desired ticket is selected by the user, a bid screen 60 for bidding for the ticket is displayed on the display unit of the user terminal 3.

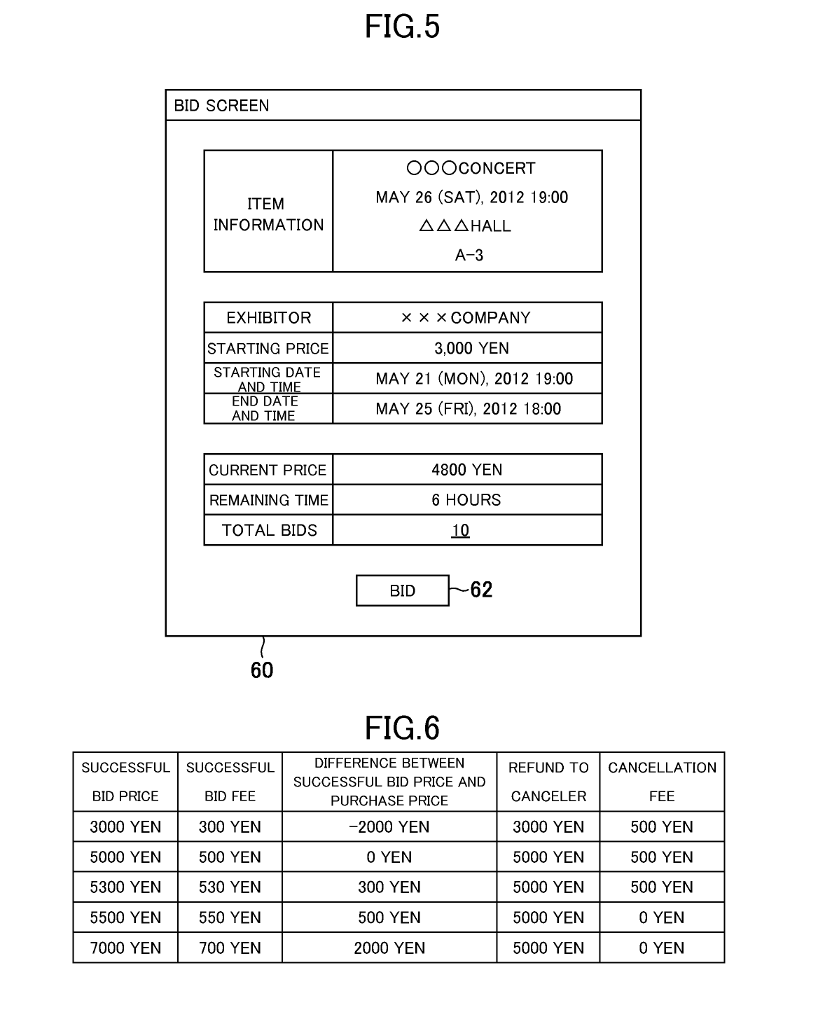

FIG. 5 illustrates an example of the bid screen. Information on an item that is put up for auction is displayed on the bid screen 60. Because the bid screen 60 illustrated in FIG. 5 is a screen for bidding for a ticket that is put up for auction, information on the ticket is displayed on the bid screen 60.

A bid button 62 is displayed on the bid screen 60. When the bid button 62 is clicked, a screen for specifying a bid price (desired purchase price) is displayed on the display unit of the user terminal 3. The user specifies the bid price on this screen.

In the auction service, a user who presents a highest bid price within a bid reception period is determined as a successful bidder. The user determined as the successful bidder can get the item at the bid price the user has presented. Accordingly, a user who wants to make a successful bid for the item needs to present a higher bid price than those of other users.

The method for the auction service is not limited to the above-mentioned method. In the auction service, for example, the price of an exhibited item may be set to the ceiling price first, and be automatically lowered gradually from a ceiling price with the passage of time. When any user bids for the item, the user may be determined as a successful bidder. In this case, the user determined as the successful bidder can get the item at the price set at the time of bidding. In this case, a user who wants to make a successful bid for the item needs to bid for the item when the price of the item drops to the desired price. In addition, the user who wants to make a successful bid for the item needs to bid for the item quicker than other users.

The user who has made a successful bid for the ticket put up for auction needs to pay an amount, which is the sum of the successful bid price and a service fee (hereinafter referred to as “successful bid fee”), to an auction company (auction service provider). The successful bidding fee is determined based on the successful bid. For example, an amount obtained by multiplying the successful bid price by a predetermined percentage (e.g., 10%) is determined as the successful bidding fee.

When a ticket cancelled by a user who purchased the ticket is bid on successfully, an amount equivalent to the successful bid price is refunded to the user who cancelled the ticket in principle. Note that, when the successful bid price is higher than the purchase price the user paid for the ticket through the ticket sales service (i.e., the sales price in the ticket sales service), an amount equivalent to the purchase price is refunded to the user. In this case, the difference between the successful bid price and the purchase price is given to the ticket selling company.

In principle, the user who cancelled the ticket needs to pay a fee originating from the cancellation of the ticket (hereinafter referred to as “cancellation fee”) to the ticket selling company. The cancellation fee is determined based on the purchase price for the ticket. For example, an amount obtained by multiplying the purchase price by a predetermined percentage (e.g., 10%) is determined as the cancellation fee.

FIG. 6 is a diagram showing an example of a successful bid fee, a cancellation fee, and a refund to a user who canceled the ticket (canceler). FIG. 6 premises that a successful bid for the ticket illustrated in FIG. 3 (i.e., ticket purchased at 5,000 yen through the ticket sales service) has been made. FIG. 6 also premises that the above-mentioned “predetermined percentage” is 10%.

The following describes a case where the successful bid price is 3,000 yen. Because the successful bid fee is 300 yen in this case, the user who has made a successful bid for the ticket needs to pay 3,300 yen. In this case, because the successful bid price is equal to or lower than the purchase price (5,000 yen), an amount (3,000 yen) equivalent to the successful bid price is refunded to the user who cancelled the ticket. Because the cancellation fee in this case is 500 yen, the substantial refund amount is the amount (2,500 yen) obtained by subtracting the successful bid fee from the successful bid price.

The following describes a case where the successful bid price is 5,000 yen. Because the successful bid fee is 500 yen in this case, the user who has made a successful bid for the ticket needs to pay 5,500 yen. In this case, because the successful bid price is equal to or lower than the purchase price (5,000 yen), an amount (5,000 yen) equivalent to the successful bid price is refunded to the user who cancelled the ticket. Because the cancellation fee in this case is 500 yen, the substantial refund amount is the amount (4,500 yen) obtained by subtracting the successful bid fee from the successful bid price.

The following describes a case where the successful bid price is 5,300 yen. Because the successful bid fee is 530 yen in this case, the user who has made a successful bid for the ticket needs to pay 5,830 yen. In this case, because the successful bid price is higher than the purchase price (5,000 yen), an amount (5,000 yen) equivalent to the purchase price is refunded to the user who cancelled the ticket. Note that, the difference (300 yen) between the successful bid price and the purchase price is given to the ticket selling company. Because the cancellation fee in this case is 500 yen, the substantial refund amount is the amount (4,500 yen) obtained by subtracting the successful bid fee from the purchase price.

The following describes a case where the successful bid price is 5,500 yen. Because the successful bid fee is 550 yen in this case, the user who has made a successful bid for the ticket needs to pay 6,050 yen. In this case, because the successful bid price is higher than the purchase price (5,000 yen), an amount (5,000 yen) equivalent to the purchase price is refunded to the user who cancelled the ticket. Note that, the difference (500 yen) between the successful bid price and the purchase price is given to the ticket selling company.

In this case, the above-mentioned difference (500 yen) is equal to the cancellation fee (500 yen). In such a case, the cancellation fee is exempted in the ticket processing system 1. As a result, the whole amount (5,000 yen) equivalent to the purchase price is refunded to the user who cancelled the ticket.

The following describes a case where the successful bid price is 7,000 yen. Because the successful bid fee is 700 yen in this case, the user who has made a successful bid for the ticket needs to pay 7,700 yen. In this case, because the successful bid price is higher than the purchase price (5,000 yen), an amount (5,000 yen) equivalent to the purchase price is refunded to the user who cancelled the ticket. Note that, the difference (2,000 yen) between the successful bid price and the purchase price is given to the ticket selling company.

In this case, the difference (2,000 yen) is higher than the cancellation fee (500 yen). In such a case, the cancellation fee is exempted in the ticket processing system 1. As a result, the whole amount (5,000 yen) equivalent to the purchase price is refunded to the user who cancelled the ticket.

Although the cancellation fee is exempted when the difference becomes equal to or higher than the normal cancellation fee (500 yen) in the above-mentioned case, the cancellation fee may be reduced when the difference is lower than the normal cancellation fee (500 yen). For example, the difference for the successful bid price of 5,300 yen is 300 yen. In this case, the amount (200 yen) obtained by subtracting the difference (300 yen) from the normal cancellation fee (5300 yen) may be charged as the cancellation fee.

According to the ticket processing system 1 described above, a ticket canceled by a user is put up for auction by the ticket selling company. Transfer of a ticket in such a ticket processing system 1 is not likely to lead to a fraud, and hence it can be expected that the promoter allows exhibition of tickets to auction. In addition, a user who wants to bid for a ticket put up for auction need not be worried about the validity of the exhibited ticket or the exhibitor. Because of those reasons, the ticket processing system 1 can make good use of canceled tickets.

The following describes the configuration for achieving the ticket processing system 1 described above. First, an example of data to be stored in the database 30 is described. FIGS. 7 to 12 show an example of data to be stored in the database 30.

FIG. 7 shows an example of a user table. The user table shows a list of users who use the ticket sales service and the auction service. For example, the user table includes fields of “user ID”, “password”, “e-mail address”, and “credit card information”.

Information (user ID) for uniquely identifying a user is registered in the “user ID” field. A password specified by the user is registered in the “password” field. The e-mail address of the user is registered in the “e-mail address” field. Information on a credit card owned by the user is registered in the “credit card information” field.

When user information is not shared between the ticket sales service and the auction service, a user table for the ticket sales service and a user table for the auction service are provided separately. In this case, the user ID in the ticket sales service differs from the user ID in the auction service, and hence data indicating the correlation between the user ID in the ticket sales service and the user ID in the auction service is needed additionally.

FIG. 8 shows an example of an event table. The event table shows a list of events in which tickets are sold through the ticket sales service. For example, the event table includes fields of “event ID”, “event name”, “date and time”, and “event site”.

Information (event ID) for uniquely identifying an event is registered in the “event ID” field. The name of an event is registered in the “event name” field. The date and time on which an event is held is registered in the “date and time” field. A site where an event is held is registered in the “event site” field.

FIG. 9 shows an example of a ticket table. The ticket table shows purchase statuses of tickets in each event. The ticket table includes fields of “event ID”, “seat”, “price”, “purchaser”, “ticket ID”, “cancel flag”, and “exhibition ID”. For example, the ticket table includes records corresponding to individual seats in each event.

The “event ID” field is identical to the “event ID” in the event table. Information (e.g., seat number) that uniquely identifies a seat is registered in the “seat” field, and a selling price is registered in the “price” field.

The user ID of a user who purchased the ticket is registered in the “purchaser” field. A seat for which a user ID is registered in the “purchaser” field has already been sold, and a seat for which a user ID is not registered in the “purchaser” field is a remaining seat. A ticket ID that uniquely identifies an electronic ticket issued to a user is registered in the “ticket ID” field.

Information indicating whether or not a user who purchased a ticket has canceled the ticket is registered in the “cancel flag” field. For example, a value “0” or “1” is registered in the “cancel flag” field. The value “0” indicates that the user has not canceled the ticket, and the value “1” indicates that the user has canceled the ticket.

The exhibition ID of a canceled ticket is registered in the “exhibition ID” field when the canceled ticket is put up for auction. The exhibition ID is information for uniquely identifying an item that is put up for auction.

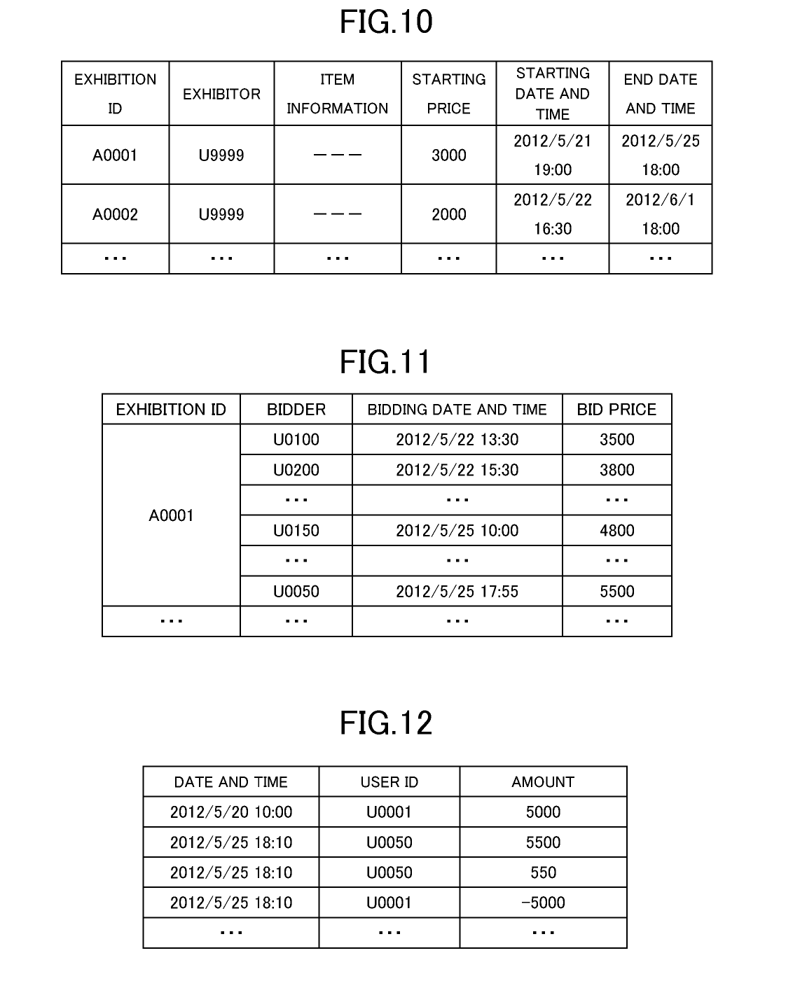

FIG. 10 shows an example of an exhibition table. The exhibition table shows a list of items that are put up for auction. For example, the exhibition table includes fields of “exhibition ID”, “exhibitor”, “item information”, “starting price”, “starting date and time”, and “end date and time”.

Information (exhibition ID) for uniquely identifying an item that is put up for auction is registered in the “exhibition ID” field. Information for uniquely identifying an exhibitor is registered in the “exhibitor” field. When a canceled ticket is put up for auction, for example, identification information of the ticket selling company is registered in the “exhibitor” field.

Information on the item that is put up for auction is registered in the “item information” field. When the item that is put up for auction is a ticket, for example, an event name, a date and time, a site, a seat, and the like are registered in the “item information” field.

A starting price is registered in the “starting price” field.

The starting price is the price of the item, which is set when the auction starts. The auction service (auction server 20) restricts the item from being made a successful bid at a successful bid price lower than the starting price. In other words, a user needs to present a price at least equal to the starting price as a bid price. Therefore, the starting price is equivalent to the minimum of the bid price (successful bid price).

The starting date and time and the end date and time are respectively registered in the “starting date and time” field and the “end date and time” field. The period from the starting date and time registered in the “starting date and time” field to the end date and time registered in the “end date and time” field is the auction period (period in which bidding from users is received).

FIG. 11 shows an example of a bid history table. The bid history table shows a bidding situation for each item that is put up for auction. For example, the bid history table includes fields of “exhibition ID”, “bidder”, “bidding date and time”, and “bid price”.

The “exhibition ID” field is identical to the “exhibition ID” field in the exhibition table. The user ID of a user who has made bidding is registered in the “bidder” field. The date and time on which bidding is made are registered in the “bidding date and time” field, and a bid price presented by the user is registered in the “bid price” field.

FIG. 12 shows an example of a charge history table. The charge history table shows a history of charging to a user. For example, the charge history table includes fields of “date and time”, “user ID”, and “amount”. The date and time on which a user is charged are registered in the “date and time” field. The user ID of the user who is to be charged is registered in the “user ID” field. A charged amount is registered in the “amount” field.

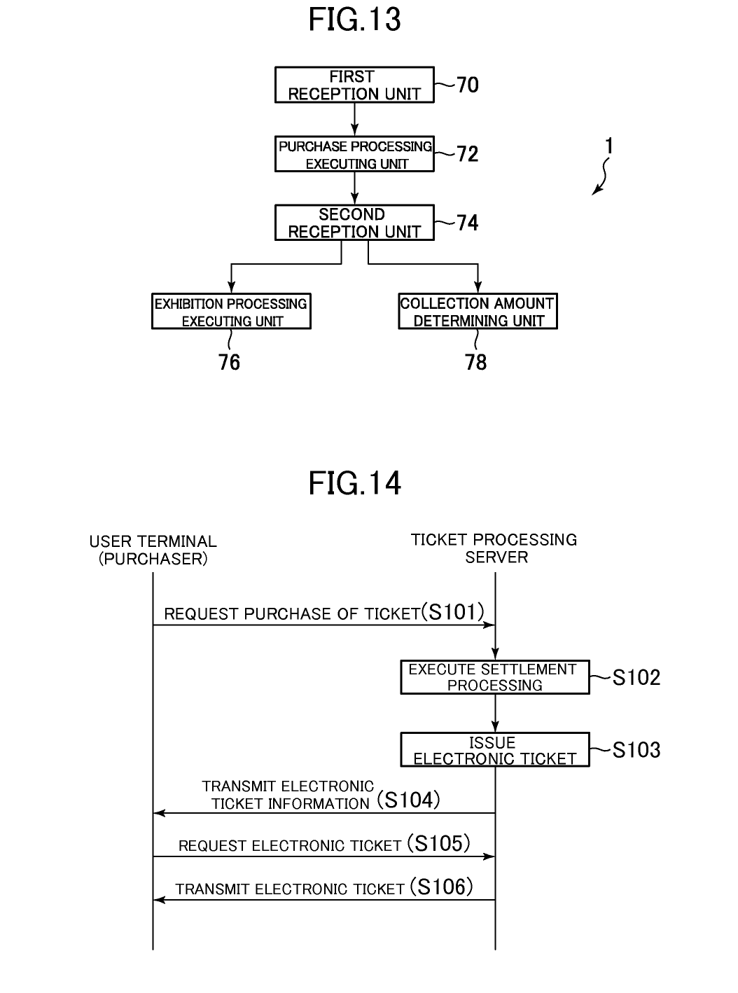

Next, functional blocks that are implemented by the ticket processing system 1 are described. FIG. 13 is a functional block diagram illustrating functional blocks which are relevant to the present invention out of the functional blocks implemented by the ticket processing system 1.

As illustrated in FIG. 13, the ticket processing system 1 includes a first reception unit 70 (first reception means), a purchase processing executing unit 72 (purchase processing executing means), a second reception unit 74 (second reception means) , an exhibition processing executing unit 76 (exhibition processing executing means), and a collection amount determining unit 78 (collection amount determining means). The individual functional blocks illustrated in FIG. 13 are implemented by, for example, the ticket processing server 10. The control unit 11 of the ticket processing server 10 executes processing in accordance with a program to thereby function as the individual functional blocks illustrated in FIG. 13.

The first reception unit 70 is described. The first reception unit 70 receives an application for purchasing a ticket from a user. When the purchase button 44 is clicked on the purchase screen 40, for example, data indicating an application for purchasing a ticket is transmitted to the ticket processing server 10 from the user terminal 3. The first reception unit 70 receives the application data transmitted from the user terminal 3.

The purchase processing executing unit 72 is described. When the application for purchasing a ticket is received, the purchase process executing unit 72 executes purchase processing of the ticket. For example, the purchase processing executing unit 72 executes processing for issuing a ticket to a user who purchased the ticket, a settlement processing, and the like.

The second reception unit 74 is described. The second reception unit 74 receives an application for canceling or transferring a ticket from a user who purchased the ticket. When the cancel (transfer) button 56 is clicked on the purchase history screen 50, for example, data indicating the application for canceling or transferring a ticket is transmitted to the ticket processing server 10 from the user terminal 3. The second reception unit 74 receives the application data transmitted from the user terminal 3.

The exhibition processing executing unit 76 is described. When the application for canceling or transferring a ticket is received, the exhibition processing executing unit 76 executes exhibition processing for putting up the ticket for auction. For example, the exhibition processing executing unit 76 requests the auction server 20 to put up the ticket for auction.

The collection amount determining unit 78 is described. When the application for canceling or transferring a ticket is received, the collection amount determining unit 78 determines an amount to be collected from the user who cancelled the ticket based on the purchase price when the user purchased the ticket and the successful bid price for the ticket that is put up for auction.

For example, the collection amount determining unit 78 determines whether or not the successful bid price is higher than a reference price which is determined based on the purchase price. The collection amount determining unit 78 then determines an amount to be collected from the user who cancelled the ticket based on the determination result.

In the example shown in FIG. 6, for example, the “reference price” is equivalent to the sum (5,500 yen) of the purchase price (5, 000 yen) and the normal cancellation fee (500 yen). In the example shown in FIG. 6, when the successful bid price is higher than the reference price (5,500 yen), a fee (cancellation fee) to be collected from the user who cancelled the ticket is zero. When the successful bid price is equal to the reference price (5,500 yen), a fee (cancellation fee) to be collected from the user who cancelled the ticket is also zero.

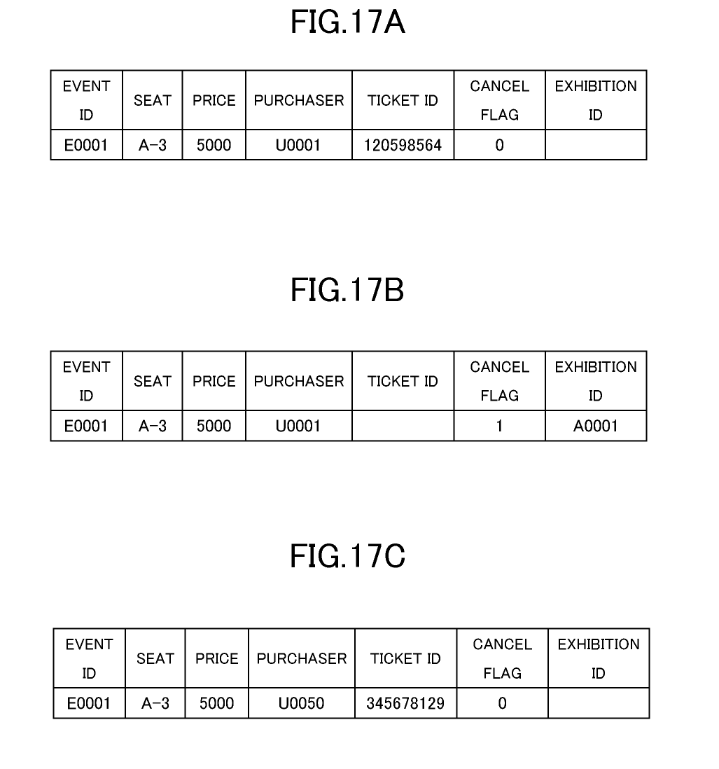

Next, processing that is executed in the ticket processing system 1 to achieve the above-mentioned functional blocks is described. FIGS. 14 to 16 illustrate an example of the processing to be executed in the ticket processing system 1. FIGS. 17A to 17C are diagrams for explaining the processing illustrated in FIGS. 14 to 16, and show examples of changes in records in the ticket table. Referring now to FIGS. 17A to 17C, the processing illustrated in FIGS. 14 to 16 is described. The control unit 11 of the ticket processing server 10 executes the processing illustrated in FIGS. 14 to 16 in accordance with the program to thereby function as the individual functional blocks illustrated in FIG. 13.

FIG. 14 illustrates an example of the processing that is executed when the purchase button 44 is clicked on the purchase screen 40.

When the purchase button 44 is clicked on the purchase screen 40, as illustrated in FIG. 14, the control unit of the user terminal 3 requests the ticket processing server 10 to purchase a ticket (S101). In this case, the user ID of the user who purchases the ticket, the event ID of an event selected by the user, and the number of tickets specified by the user are transmitted to the ticket processing server 10.

When the control unit 11 (the first reception unit 70) of the ticket processing server 10 receives the request, the control unit (the purchase processing executing unit 72) of the ticket processing server 10 executes the settlement processing (S102). For example, the settlement processing is executed based on credit card information associated with the user ID received from the user terminal 3.

The control unit 11 (the purchase processing executing unit 72) issues an electronic ticket to the user who purchased the ticket (S103). For example, the control unit 11 determines a seat to be provided to the user. In addition, the control unit 11 generates a ticket ID for the seat to be provided to the user. The ticket ID is generated in such a way as not to overlap existing ticket IDs. Then, the control unit 11 accesses the ticket table to register the generated ticket ID in association with the seat to be provided to the user.

In the example illustrated in FIG. 17A, for example, a seat “A-3” in an event “E0001” is determined as a seat to be provided to a user “U0001”. In the example illustrated in FIG. 17A, “120598564” is generated as a ticket ID, and the ticket ID “120598564” is associated with the seat “A-3”.

When Step S103 is completed, the control unit 11 transmits electronic ticket information to the user who purchased the ticket (S104). The electronic ticket information is information on the electronic ticket issued in Step S103, and includes, for example, URL information for acquiring the electronic ticket and message information indicating that issuance of the electronic ticket is completed.

In the user terminal 3 that has received the electronic ticket information, when the user executes a predetermined operation, the control unit 11 requests the ticket processing server 10 for the electronic ticket (S105). Then, the control unit 11 of the ticket processing server 10 that has received the request transmits the electronic ticket to the user terminal 3 (S106).

For example, data of the purchase history screen 50 is transmitted to the user terminal 3 in Step S104. In addition, an e-mail indicating URL information for acquiring the electronic ticket is transmitted to the user. When the display button 52 or the print button 54 on the purchase history screen 50 is clicked, or when the URL information described in the e-mail is specified, the above-mentioned request is transmitted to the ticket processing server 10 from the user terminal 3 (S105). In this case, the control unit 11 of the ticket processing server 10 generates a code image indicating a ticket ID, and transmits the code image to the user terminal 3 (S106). Then, the code image received from the ticket processing server 10 is displayed on the display unit of the user terminal 3, or output from a printer connected to the user terminal 3 in a communicable manner.

At the time of entering an event site on the day of the event, the user presents the user terminal 3 displaying the code image or a paper having the code image printed thereon. In this case, the code image is read by a reader, and the ticket ID indicated by the code image is transmitted to the ticket processing server 10. The ticket processing server 10 refers to the ticket table to verify whether or not the ticket ID is valid. When it is verified that the ticket ID is valid, the user can enter the event site.

Alternatively, in Step S104, message information indicating the completion of the issuance of the electronic ticket is transmitted to the user by e-mail or the like. The user who has received the e-mail activates, for example, an application program for electronic tickets on the user terminal 3. This application program is, for example, an application program for permitting the user terminal 3 to serve as a ticket by using the NFC contactless IC card function of the user terminal 3. When this application program is activated, the above-mentioned request is transmitted to the ticket processing server 10 from the user terminal 3 (S105). In this case, the control unit 11 of the ticket processing server 10 transmits the ticket ID to the user terminal 3 (S106). The above-mentioned application program in the user terminal 3 uses the ticket ID so that the user terminal 3 serves as the ticket.

At the time of entering an event site on the day of the event, the user presents the user terminal 3 on which the application program is activated. In this case, the application program and the reader exchange the ticket ID using the NFC contactless IC card function, thereby transmitting the ticket ID to the ticket processing server 10. The ticket processing server 10 refers to the ticket table to verify whether or not the ticket ID is valid. When it is verified that the ticket ID is valid, the user can enter the event site. The above completes the description of the processing illustrated in FIG. 14.

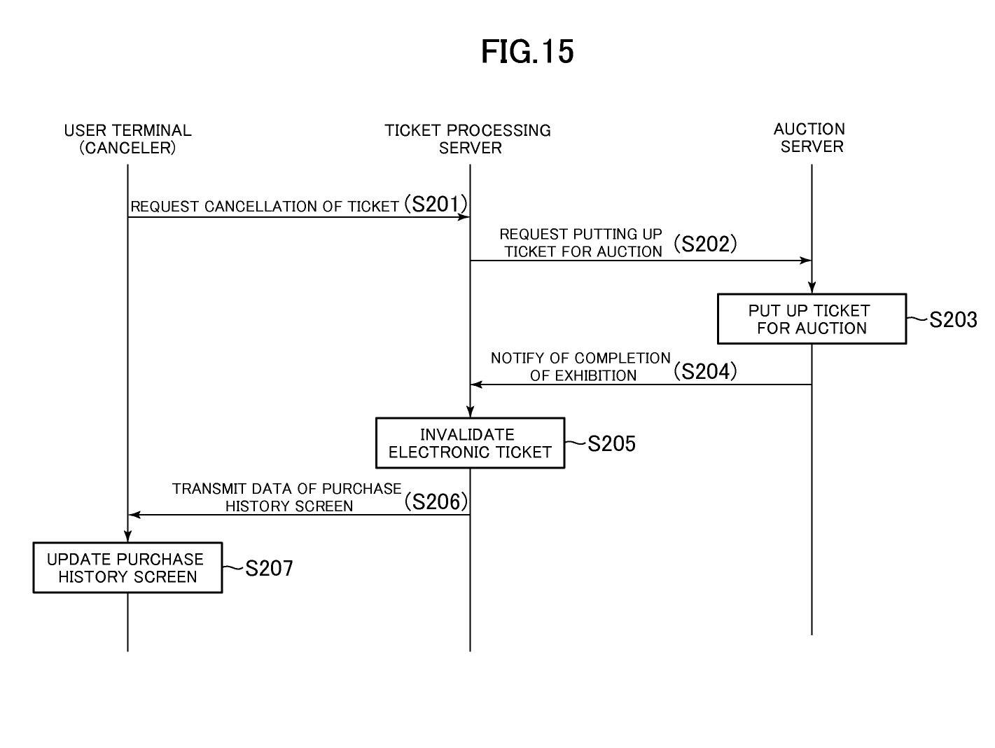

FIG. 15 illustrates an example of processing that is executed when any cancel (transfer) button on the purchase history screen 50 is clicked.

When any cancel (transfer) button 56 on the purchase history screen 50 is clicked, the control unit of the user terminal 3 requests the ticket processing server 10 to cancel the ticket selected as a cancellation target (S201). In this case, the user ID of the user who cancelled the ticket and the ticket ID of the ticket selected by the user as the cancellation target are transmitted to the ticket processing server 10.

When the request is received by the control unit 11 (the second reception unit 74) of the ticket processing server 10, the control unit 11 of the ticket processing server 10 accesses the ticket table to verify that the user ID and the ticket ID received from the user terminal 3 are associated with each other. After the verification, the control unit 11 (the exhibition processing executing unit 76) requests the auction server 20 to put up the ticket for auction (S202). In this case, information on the ticket (e.g., event name, date and time, site, seat, and selling price) is transmitted to the auction server 20.

Note that, when the auction service is provided by a provider different from the ticket selling company, data verifying that the provider requesting exhibition to auction is the same as the provider who sold the ticket to be exhibited may also be transmitted to the auction server 20. The request for exhibition to auction may be received only when the auction server 20 verifies that the provider requesting exhibition to auction is the same as the provider who sold the ticket to be exhibited.

When the auction server 20 receives the request for exhibition to auction, the control unit of the auction server 20 puts up the ticket selected as a cancellation target for auction (S203).

For example, the control unit accesses the exhibition table to add a new record thereto. In this case, the control unit generates an exhibition ID, and registers the exhibition ID in the “exhibition ID” field of the record. The control unit registers the ID of the ticket selling company in the “exhibitor” field of the record. Further, the control unit registers the information received from the ticket processing server 10 (e.g., event name, date and time, site, seat, and selling price) in the “item information” field of the record.

In addition, the control unit registers the starting price (minimum price) in the “starting price” field of the record. For example, a predetermined price is registered in the “starting price” field. Alternatively, the price that is determined based on the selling price in the ticket sales service (i.e., purchase price when the ticket was purchased through the ticket sales service) is registered in the “starting price” field. For example, an amount obtained by multiplying the selling price by a predetermined percentage is registered in the “starting price” field. Setting the “starting price” field in this way can prevent the successful bid price for the ticket from dropping too low.

Alternatively, the price that is specified as the starting price (minimum price) by the user who cancels the ticket may be registered in the “starting price” field. When the cancel (transfer) button 56 is clicked, for example, a screen for receiving designation of the starting price may be displayed on the display unit of the user terminal 3. Alternatively, the price specified as the starting price by the user who cancels the ticket may be transmitted to the auction server 20 via the ticket processing server 10. The auction server 20 may acquire the price transmitted in the above-mentioned manner, and the price may be registered in the “starting price”. This allows the user who cancels the ticket to prevent the successful bid price for the ticket from dropping too low.

The control unit registers the starting date and time and the end date and time in the “starting date and time” and “end date and time”, respectively, of the record. For example, the current date and time is registered in the “starting date and time” field. Further, a date and time that is determined based on the date and time on which the event is held is registered in the “end date and time” field. For example, a date and time earlier by a predetermined period of time than the date and time on which the event is held is registered in the “end date and time” field. Note that, the date and time determined based on the starting date and time may be registered in the “end date and time” field. For example, a date and time later by a predetermined period of time than the starting date and time may be registered in the “end date and time” field.

After Step S203, the control unit notifies the ticket processing server 10 of the completion of exhibition to auction (S204). In this case, the ticket processing server 10 is notified of the exhibition ID of the ticket that is put up for auction. In other words, the ticket processing server 10 is notified of the exhibition ID that has been generated in Step S203 and registered in the “exhibition ID” field.

When the ticket processing server 10 receives the notification, the control unit 11 of the ticket processing server 10 accesses the ticket table, and invalidates the electronic ticket issued to the user who cancelled the ticket (S205).

Such a case where the ticket with the ticket ID of “120598564” as shown in FIG. 17A is put up for auction is assumed. In this case, the “cancel flag” field of the record where “120598564” is registered in the “ticket ID” field is updated to “1” from “0” as shown in FIG. 17B. Further, the exhibition ID notified from the auction server 20 is registered in the “exhibition ID” field of the record.

Further, the ticket ID (120598564) registered in the “ticket ID” field of the record is deleted. As a result, the use of the ticket ID “120598564” is disabled. For example, even if the code image indicating the ticket ID “120598564” has already been saved in the user terminal 3 and is presented on the day of the event at the event site, it is not determined that the ticket ID “120598564” is valid because the ticket ID “120598564” has been deleted from the ticket table. That is, security is provided to prevent a canceled ticket from being abused so that a user who has made a successful bid for the ticket feels secure to use the ticket.

When Step S205 is completed, the control unit 11 generates data of the purchase history screen 50 with the canceled ticket removed therefrom, and transmits the data to the user terminal 3 (S206). In this case, the control unit of the user terminal 3 updates the purchase history screen 50 displayed on the display unit based on the data received from the ticket processing server 10 (S207). The above completes the description of the processing illustrated in FIG. 15.

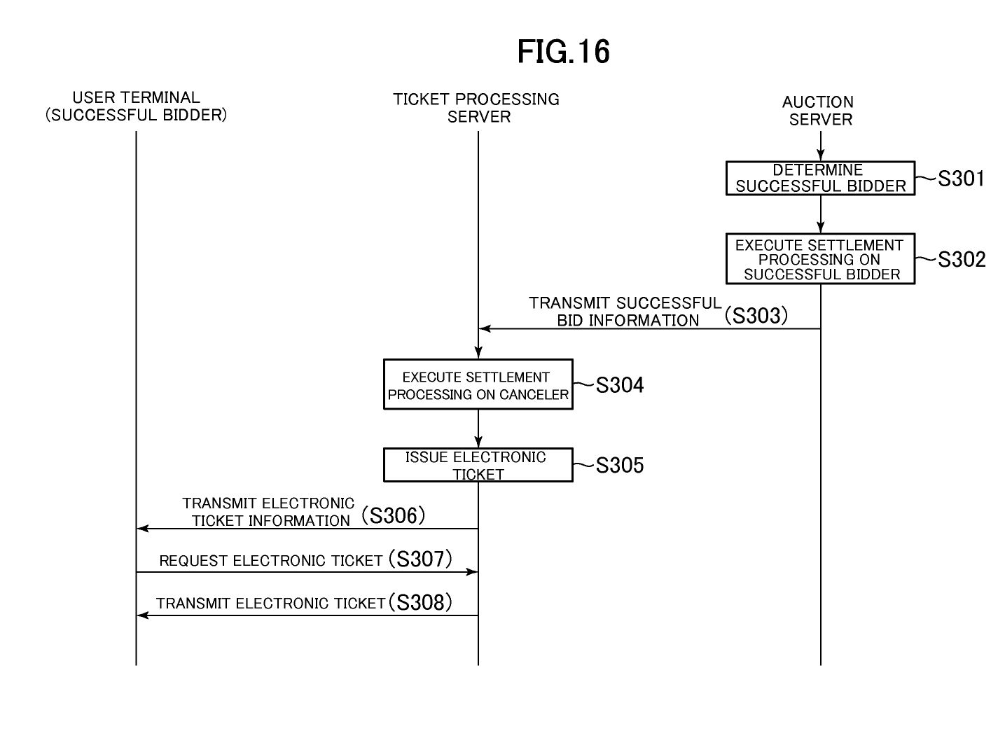

FIG. 16 illustrates an example of processing that is executed when the auction period for a ticket that is put up for the auction service by the ticket processing server 10 ends.

When the auction period for the ticket that is put up for auction by the ticket processing server 10 ends, the control unit in the auction server 20 determines a successful bidder (S301). For example, the control unit accesses the bid history table to determine a user who has presented the highest bid price as the successful bidder. Further, the control unit determines, as the successful bid price, the bid price presented by the user who has been determined as the successful bidder.

Although a description is omitted herein for the sake of descriptive convenience, a user who has presented the highest bid price may be asked whether or not the user intends to make a successful bid for the item before the successful bidder is determined. The user who has presented the highest bid price may be determined as the successful bidder only when the user who has presented the highest bid price has expressed the above-mentioned intention.

After Step S301 is completed, the control unit executes the settlement processing on the user who has made a successful bid for the ticket (S302). For example, the control unit collects an amount equivalent to the successful bid price from the user who has made a successful bid for the ticket, based on credit card information associated with the user ID of the user who has made a successful bid for the ticket. Further, the control unit collects an amount equivalent to 10% of the successful bid price as the successful bid fee from the user who has made a successful bid for the ticket.

When the ticket selling company differs from the auction company, the auction company delivers an amount equivalent to the successful bid price to the ticket selling company. In this case, the auction company may collect a fee (bid fee) from the ticket selling company.

After Step S302 is completed, the control unit transmits successful bid information to the ticket processing server 10 (S303). For example, the user ID of the user who has made a successful bid for the ticket and the successful bid price are transmitted as the successful bid information to the ticket processing server 10.

When the ticket processing server 10 receives the successful bid information, the control unit 11 of the ticket processing server 10 executes the settlement processing on the user who cancelled the ticket (S304).

For example, the control unit 11 determines whether or not the successful bid price is equal to or lower than the selling price in the ticket sales service. When the successful bid price is equal to or lower than the selling price, the control unit 11 refunds an amount equivalent to the successful bid price to the user who cancelled the ticket. When the successful bid price is higher than the selling price, on the other hand, the control unit 11 refunds an amount equivalent to the selling price to the user who cancelled the ticket.

Further, the control unit 11 determines whether or not the successful bid price is higher than the reference price. For example, the control unit 11 sets the reference price based on the selling price in the ticket sales service and the normal cancellation fee. More specifically, the control unit 11 sets an amount obtained by adding the selling price in the ticket sales service and the normal cancellation fee as the reference price. The normal cancellation fee is an amount obtained by multiplying the selling price in the ticket sales service by a predetermined percentage (e.g., 10%). Alternatively, the normal cancellation fee may be a predetermined amount.

When the successful bid price is equal to or lower than the reference price, the control unit 11 (the collection amount determining unit 78) collects the normal cancellation fee from the user who cancelled the ticket. When the successful bid price is higher than the reference price, on the other hand, the control unit 11 (the collection amount determining unit 78) does not collect the cancellation fee from the user who cancelled the ticket.

After Step S304 is completed, the control unit 11 issues a new electronic ticket to the user who has made a successful bid for the ticket (S305). Step S305 is basically the same as Step S103 of FIG. 14.

Such a case where the user “U0050” has made a successful bid for the ticket with the exhibition ID of “A0001” as shown in FIG. 17B is assumed. In this case, the “user ID” field of the record where “A0001” is registered in the “exhibition ID” field is updated to “U0050” as shown in FIG. 17C. Further, a ticket ID is newly generated, and is registered in the “ticket ID” field of the record. Further, the “cancel flag” of the record is updated to “0” from “1”, and the exhibition ID registered in the “exhibition ID” field of the record is deleted.

Note that, Step S205 of FIG. 15 may be omitted, and in Step 305, the “ticket ID” field in the record may be updated from an original ticket ID (i.e., ticket ID issued to the user who cancelled the ticket) to the newly generated ticket ID (i.e., ticket ID newly issued to the user who made a successful bid for the ticket).

After Step S305 is completed, the control unit 11 transmits electronic ticket information to the user terminal 3 of the user who has made a successful bid for the ticket (S306). When the user terminal 3 of the user who has made a successful bid for the ticket requests the ticket processing server 10 for an electronic ticket (S307), the control unit 11 of the ticket processing server 10 transmits the electronic ticket to the user terminal 3 of the user who has made a successful bid for the ticket (S308). Because Steps S306 to S308 are similar to Steps S104 to S106, their descriptions are omitted. The above ends the description of the processing illustrated in FIG. 16.

When the ticket has not been bid on successfully (e.g., when no users have bidden), processing as described below is executed instead of Steps S301 to S308.

Specifically, when the ticket has not been bid on successfully, the control unit of the auction server 20 notifies the ticket processing server 10 of unsuccessful bidding of the ticket along with the exhibition ID.

In this case, cancellation (transfer) of the ticket has not been successful, and the ticket processing server 10 that has received the above-mentioned notification then executes processing for setting the status of the ticket back to the status before the cancel (transfer) button 56 has been clicked. In other words, processing of returning the ticket to the user (the user who has tried to cancel the ticket) is executed. Specifically, the control unit 11 accesses the ticket table to update the record where the exhibition ID received from the auction server 20 is registered in the “exhibition ID” field.

In other words, the control unit 11 generates a ticket ID again for the user who failed to cancel (transfer) the ticket, and registers the ticket ID in the “ticket ID” field of the record. Further, the control unit 11 updates the “cancel flag” field of the record from “1” to “0”. Further, the control unit 11 deletes the exhibition ID registered in the “exhibition ID” field of the record.

In addition, the control unit 11 transmits message information indicating that cancellation (transfer) of the ticket has not been successful, together with electronic ticket information (e.g., URL information) relating to the reissued electronic ticket, to the user by e-mail or the like.

Although the ticket is returned to the user who failed to cancel (transfer) the ticket when the ticket is not bid on successfully in the above-mentioned processing, the ticket may not be returned to the user. For example, the control unit 11 may put up the ticket for auction again. Alternatively, the control unit 11 may set the ticket to such a status that the ticket can be sold in the ticket sales service. When the ticket is set to such a status that the ticket can be sold in the ticket sales service, the control unit 11 accesses the ticket table to specify a record where the exhibition ID received from the auction server 20 is registered in the “exhibition ID” field, and deletes information registered in the “purchaser” field, “ticket ID” field, “cancel flag” field, and “exhibition ID” field of the record. The above ends the description of the processing that is executed when a ticket is not bid on successfully.

According to the ticket processing system 1 described above, a canceled ticket is put up for auction by a ticket selling company. According to such a ticket processing system 1, transfer of a ticket is not likely to lead to a fraud, and hence it can be expected that the promoter allows exhibition of tickets to auction. In addition, a user who wants to bid for a ticket that is put up for auction need not be worried about the validity of the exhibited ticket or the exhibitor. The ticket processing system 1 can therefore make good use of canceled tickets.

In the ticket processing system 1, exhibition of a ticket to auction is executed by the ticket processing server 10, and hence a user need not personally put up a ticket for auction. Accordingly, the ticket processing system 1 can reduce a user's work of putting up a ticket for auction. In other words, the ticket processing system 1 can make good use of tickets canceled by users while reducing the users' works. That is, the ticket processing system 1 has a technical advantage of reducing a user's work.

The ticket processing system 1 is advantageous in that all or part of the price of a purchased ticket may be refunded to a user who needs to cancel the purchased ticket for an unavoidable reason. There is another advantage in that the cancellation fee may be exempted (or reduced). The ticket processing system 1 has a further advantage in that a user need not execute a work of putting up an item for the auction service.

The ticket processing system 1 is also advantageous in that a user who failed to purchase a ticket can get the ticket in auction without worrying about the validity of the ticket that is put up for auction or exhibitor.

Moreover, according to the ticket processing system 1, achieving good use of tickets makes occurrence of empty seats in an event site difficult. Therefore, there is an advantage for the promoter to make occurrence of empty seats in an event site difficult. There are further advantages for the ticket selling company or the auction company to be able to improve the satisfaction of users using its own service, and to be able to expect an increase in fee income.

The present invention is not limited to the above-mentioned embodiment.

[1] As described above, the price of an exhibited item may be reduced from the maximum price with the passage of time in the auction service. When an application for bidding for an item is received from a user, the price upon reception of the application may be determined as the successful bid price.

In this case, for example, the auction server 20 may receive bidding from a user even on the day of the event. Further, the auction server 20 may receive bidding from a user even after the event has started. This modification allows a user who wants to get a ticket to get the ticket on the day of the event or even after the even has started.

When bidding from a user is received on the day of the event, the auction server 20 (price control means) may set the reduction speed of the price (the rate of reduction in price per unit time) on the day of the event (day specified by the ticket) greater than the reduction speed of the price before the day of the event. For example, the price may be reduced by 500 yen per day before the day of the event, and may be reduced by 100 yen per hour on the day of the event.

When bidding from a user is received after the event has started, the auction server 20 (price control means) may set the reduction speed of the price after the starting date and time of the event (date and time specified by the ticket) greater than the reduction speed of the price before the starting date and time of the event. For example, the price may be reduced by 500 yen per day before the start of the event, and may be reduced by 100 yen per ten minutes after the event has started.

Further, for example, the price maybe reduced by 500 yen per day before the day of the event, may be reduced by 100 yen per hour before the start of the event on the day of the event, and may be reduced by 100 yen per ten minutes after the start of the event.

[2] When the ticket put up for the auction service is not bid on successfully, for example, the ticket processing server 10 may transfer the ticket to a user who has a predetermined relation with the user who cancelled the ticket. The “user who has the predetermined relation with the user who cancelled the ticket” is, for example, a user who is a friend of the user who cancelled the ticket.

To achieve the above-mentioned transfer of a ticket, data showing that both users have the predetermined relation is necessary. For example, data showing the combination of user IDs of users who have the predetermined relation with each other is needed. Such data may be stored in the database 30, or may be stored in another database. When the above-mentioned data is present in a database included in a communication system for providing a communication service (e.g., social network service) to achieve communications among users, for example, the ticket processing server 10 may acquire the above-mentioned data from the database included in the communication system.

In transferring a ticket to a user who has the predetermined relation with the user who cancelled the ticket, a new electronic ticket is issued to this user. This processing is basically the same as the processing in Step S305 of FIG. 16.

The above-mentioned ticket transfer may be carried out for free or at some price. In a case of transferring a ticket at some price, the price for the ticket may be a predetermined price, or a price (desired transfer price) specified by the user who cancelled the ticket. In the latter case, the desired transfer price may be notified to the user who has the predetermined relation with the user who cancelled the ticket. Additionally, the ticket may be transferred when the notified user approves the desired transfer price.

[3] A user may be able to select what to do if the ticket put up for auction is not is bid on successfully. When the ticket put up for auction is not bid on successfully, for example, the user who cancelled the ticket may select whether or not to transfer the ticket to the user who has the predetermined relation with himself/herself.

[4] When the user who has purchased a plurality of tickets wants to cancel the tickets, those tickets maybe put up for auction collectively, or may be put up for auction individually.

[5] Although the foregoing description has been given of the case where the present invention is applied to the ticket processing system 1 for issuing electronic tickets to users, the present invention may also be applied to a ticket processing system for issuing conventional physical tickets (e.g., paper tickets) to users.

### DESCRIPTION OF REFERENCE NUMERAL

1 ticket processing system, 2 communication network, 3 user terminal, 10 ticket processing server, 11 control unit, 12 storage unit, 13 optical disk drive unit, 14 communication unit, 20 auction server, 30 database, 40 purchase screen, 42 number-of-tickets field, 44 purchase button, 50 purchase history screen, 52 display button, 54 print button, 56 cancel (transfer) button, 60 bid screen, 62 bid button, 70 first reception unit, 72 purchase processing executing unit, 74 second reception unit, 76 exhibition processing executing unit, 78 collection amount determining unit.

The invention claimed is:

1. A ticket processing system, comprising:
a first reception unit that receives, from a user, an application for purchasing a ticket;
a purchase processing executing unit that executes purchase processing of the ticket in a case where the application for purchasing the ticket is received;
a second reception unit that receives an application for canceling or transferring of the ticket from a purchasing user who has purchased the ticket; and
an exhibition processing executing unit that executes exhibition processing for putting up the ticket for an auction service in a case where the application for the canceling or transferring of the ticket is received.

2. The ticket processing system according to claim 1, further comprising:
a collection amount determining unit that determines, in a case where the ticket which is put up for the auction service is bid on successfully, an amount to be collected from the purchasing user who has made the application for the canceling or transferring of the ticket, based on a purchase price when the purchasing user has purchased the ticket and a successful bid price for the ticket in the auction service.

3. The ticket processing system according to claim 2, wherein
the collection amount determining unit determines the amount to be collected from the purchasing user based on a result of determination as to whether the successful bid price is higher than a reference price which is determined based on the purchase price.

4. The ticket processing system according to claim 3, wherein
the collection amount determining unit determines that the amount to be collected from the purchasing user is zero in a case where the successful bid price is higher than the reference price.

5. The ticket processing system according to claim 1,
wherein the purchase processing executing unit comprises a unit that executes processing for issuing an ticket to the purchasing user, and
wherein the ticket processing system further comprises:
a unit that executes processing for disabling use of the ticket issued to the purchasing user in the case where the application for the canceling or transferring of the ticket is received; and
a unit that executes processing for issuing a new ticket to a user who has made a successful bid for the ticket in the case where the ticket which is put up for the auction service is bid on successfully.

6. The ticket processing system according to claim 1 further comprising:
a unit that determines a minimum price; and
a unit that restricts a successful bid for the ticket from being made at a successful bid price lower than the minimum price in the auction service.

7. The ticket processing system according to claim 1, further comprising:
a price control unit that reduces a price of the ticket which is put up for the auction service with passage of time;
a unit that receives an application for bidding for the ticket which is put up for the auction service from a user; and
a unit that determines a price at a time when the application for bidding for the ticket is received as a successful bid price,
wherein the price control unit comprises at least one of:
a unit that sets a speed of reducing the price on a day specified by the ticket greater than a speed of reducing the price before the day specified by the ticket; or
a unit that sets the speed of reducing the speed after a date and time specified by the ticket greater than the speed of reducing the price before the date and time specified by the ticket.

8. The ticket processing system according to claim 1, further comprising:
a unit that executes processing for transferring the ticket to a user who has a predetermined relationship with the purchasing user in a case where the ticket which is put up for the auction service is not bid on successfully.

9. A control method for a ticket processing system, the control method comprising:
receiving, from a user, an application for purchasing a ticket;
executing purchase processing of the ticket in a case where the application for purchasing the ticket is received;
receiving an application for canceling or transferring of the ticket from a purchasing user who has purchased the ticket; and
executing exhibition processing for putting up the ticket for an auction service in a case where the application for the canceling or transferring of the ticket is received.

10. (canceled)
